(19) United States
(12) Patent Application Publication
(10) Pub. No.: US 2010/0036011 A1
(43) Pub. Date: Feb. 11, 2010

(54) NEW TYPES OF COMPATIBILISING AGENTS FOR IMPROVING THE STORAGE OF POLYOL MIXTURES

(76) Inventors: Berend-Jan DE GANS, Muelheim a.d. Ruhr (DE); Martin Glos, Borken (DE); Michael Ferenz, Essen (DE)

Correspondence Address: FROMMER LAWRENCE & HAUG, 745 FIFTH AVENUE- 10TH FL., NEW YORK, NY, 10151, US

(21) Appl. No.: 12/364,283

(22) Filed: Feb. 2, 2009

(30) Foreign Application Priority Data
Feb. 6, 2008 (DE) 102008000243.7

(51) Int. Cl. C08G 18/32; C08G 18/00; C08G 63/08

(52) U.S. Cl. 521/170; 525/452; 525/450

(57) ABSTRACT

The invention relates to polyethers containing urethane or urea groups as compatibilizing agents, their preparation and use, obtained by the reaction of
A. at least one di- and/or polyisocyanate with
B. (a) at least one hydrophilic polyether which randomly carries at least one OH and/or NH₂ and/or NH function and
   (b) at least one hydrophobic polyether which randomly comprises at least one OH and/or NH₂ and/or NH function and
   (c) optionally further compounds which carry at least one OH and/or NH₂ and/or NH function and/or other isocyanate-reactive groups such as carboxylic acid or epoxide functions, and
      with the proviso that at least one isocyanate A is difunctional or multifunctional.

This application claims benefit under 35 U.S.C. 119(a) of German patent application 102008000243.7 filed on 6 Feb. 2008.

Any foregoing applications, including German patent application DE 102008000243.7, and all documents cited therein or during their prosecution (“application cited documents”) and all documents cited or referenced in the application cited documents, and all documents cited or referenced herein (“herein cited documents”), and all documents cited or referenced in herein cited documents, together with any manufacturer's instructions, descriptions, product specifications, and product sheets for any products mentioned herein or in any document incorporated by reference herein, are hereby incorporated herein by reference, and may be employed in the practice of the invention.

The invention relates to new types of compatibilizing agents for improving the storage stability of polyol compositions of immiscible polyols, homogeneous polyol mixtures comprising these compatibilizing agents and use thereof for the preparation of foams by reacting the polyol mixtures with polyisocyanates, where polyurethane and/or polyisocyanurate and/or polyurea foams are formed.

Homogeneous mixtures are to be understood here as meaning mixtures of two or more components, here polyol compositions, which have no visible phase separation. Homogeneous mixtures of this type can arise in various forms such as, for example, as (true) solutions, emulsions, microemulsions, etc.

Substances which favour the formation of such homogeneous mixtures, irrespective of whether in aqueous or nonaqueous medium or else together with solids, are referred to in this application as compatibilizing agents.

Polyurethane foams are used in diverse applications, for example for thermal insulation, for energy absorption and for sound absorption. It is therefore necessary to produce polyurethanes in different precisely adjusted specifications/parameters. These important parameters include, for example, mechanical properties, the density and the moulding time.

In the industrial production of polyurethane foams, polyols and in particular polyol mixtures are used as reactive component for the reaction with polyisocyanates. The properties of the foam formed depend to a particular degree on the structure and the chemical composition of the polyol mixtures used.

In the PU industry (foam sector), highly diverse types of polyols are used. First, for example, there is the division according to polyether-polyols and polyester-polyols, depending on the appearance of the chemical structure of the compounds.

Furthermore, in the case of the polyols, distinctions are made according to the synthesis route of this important class of compounds. Thus, the polyols can be based on renewable raw materials and thus satisfy the modern concept of renewability. Such polyols produced from renewable raw materials are therefore referred to as NOPs (natural oil based polyols). These include representatives of the, for example, vegetable oils or extracts of vegetable raw materials for whose production no or only a small number of chemical changes/synthesis steps are required.

EP-1537159(US 2006167125) describes the preparation of polyols for the production of polyurethane foams using castor-oil-based alkoxylates.

EP-1712576(US 2006229375) describes the use of alkoxylates of vegetable oils as polyols in the production of polyurethanes.

WO-00/00529 describes the production of PU foams using castor oil as polyol.

The hydroxyl-group-containing vegetable oils and modified hydroxyl-group-containing vegetable oils used have OH numbers in the range from 100 to 300. Castor oil or modified castor oil with OH numbers from 150 to 160 is particularly suitable.

EP-1765901 describes polyols for the production of rigid PU foam which are produced on the basis of CNSL by epoxidation of the double bonds in the alkyl side chain and subsequent ring opening in order to increase the OH number of the polyol.

Current trends are, for example, the use of nature-based polyols (NOPs), which are mixed with conventional petroleum-based polyols or, more generally, the use of at least two polyols which have different polarities e.g. as a result of differing contents of polyethylene oxide. In both cases, the problem arises that the polyols to be foamed (processed) are no longer soluble in one another and the polyol mixture is an emulsion or dispersion which often only has limited storage stability; within the context of the application, such mixtures are referred to as incompatible with one another.

US-20070238800 thus describes a storage-stable composition which is reactive towards isocyanates and comprises at least 10% of a vegetable-oil-based polyol, where nonylphenol ethoxylates with at least 25 EO (ethylene oxide units) are described for improving the storage stability.

Only complex mixtures of polyether polyols with castor-oil-based polyol comprising at least five components are described here. The solubility problems with polyesterpolyols and vegetable-oil-based polyols described in this application cannot be solved using the method described therein. Not least because synthetic polyols also have to be used alongside the use of vegetable-oil-based polyols.

Especially if a corresponding polyol mixture cannot be used straight away after its production or if there is no possibility of stirring it continuously until it is used in order to keep it homogeneous, a corresponding storage stability is absolutely necessary.

Polyol mixtures for foaming are often mixed with all of the necessary components, apart from the isocyanate, and the mixture is transported in this form and stored until foaming. For this, the substances required and known according to the prior art can be added to the polyols, such as, for example, propellants, stabilizers, catalysts, dyes, flame retardants, and also further auxiliaries which are required for the processing, production and use of the foam. Polyol mixtures comprising such additives are also referred to as “systems” or, in the European sector, as “A component”.

In further consideration, the term polyol mixture is to be understood as meaning both the polyol mixtures themselves and also the mixtures containing the aforementioned additives.

For a diverse applicability of the polyol mixture, it is necessary that they can be used directly on site and at the time of their use with the lowest possible expenditure. In this connection, the polyol mixture is present in particular in homogeneous form, i.e. for example in the case of the presence of a true solution, a single-phase system, but also in the case of stable emulsions, the emulgate which has not separated over a prolonged period. This is of importance particularly if the polyol mixtures cannot be used directly but have to be stored under the various transportation and storage conditions occurring in practice (thermal stress, fluctuating temperatures, lack of agitation possibility, etc.).

Methods customary in practice for producing and for retaining the homogeneity and/or preventing phase separation of the systems consisted in keeping the components moving in the storage and distribution tanks using costly stirrers or through continuous circulation by pumping. However, prevention of separation of the components and adequate homogenisation are not always ensured with certainty even using these industrially complex measures.

In the case of inadequate homogenisation, during the mixing with the polyisocyanates, the stoichiometry, i.e. the pregiven ratio of the polyols in the polyol mixture, of the reactive mixture in the ranges of inhomogeneity is no longer correct. Observing the required important parameters of the components matched to one another is in these cases no longer ensured, resulting in the production of diffractive polyurethane foams.

Attempts have therefore been made to overcome these disadvantages using dispersion and/or emulsifying auxiliaries.

Thus, WO-2005/085310(US 2007270518) proposed a prepolymer composition, in particular for producing polyurethane expanding and insulating foams, where the prepolymer composition comprises polyurethane prepolymers from the reaction of a first component which comprises hydrophobic polyesterpolyols with at least two hydroxy groups and a second component which comprises polyisocyanates with at least two isocyanate groups, which is characterized in that the polyesterpolyols are at least partially transesterification products of vegetable or animal oils with aromatic di- and/or tricarboxylic acids, esters or anhydrides thereof, and polyols.

EP-0909792 describes 1C-polyurethane synthesis compositions comprising a synthetic polymer (T) as emulsifier, consisting of
(I) a copolymer backbone (TR), formed from
   (TR1) at least one ethylenically unsaturated C₄-C₁₂-dicarboxylic acid, anhydride thereof or mixtures thereof,
   (TR2) at least one C₂-C₄₀-olefin, and
(II) a polyalkylene oxide (TP) starting from the copolymer backbone, formed from (TP1) at least one C₂- to C₂₀-oxirane.

The further components of the 1C polyurethane synthesis compositions present are a first and a second compound with at least two reactive hydrogen atoms (a), where the first compound is insoluble in the second compound, where the first compound is a polyetherpolyol having propylene oxide and ethylene oxide, and the second compound is a C₂-C₂₀-alkylenediol, and the first compound is insoluble in the second compound, if a 1:1 mixture of the two compounds is subjected to a phase separation within a month following preparation of the mixture if the mixture is not agitated.

In the case of this special application in the 1C foam, no vegetable-oil-based polyols are used.

The mixtures prepared in this way comprise very complex synthetic polymeric systems which are only accessible through complex synthesis.

EP-1 161 474 relates to a process for the preparation of open-cell polyurethane foams by reacting polyisocyanates with a polyol component present as aqueous emulsion consisting of a mixture of at least one water-immiscible polyol and at least one polyesterpolyol or polyester polyether polyol. It is essential for the process therein that the polyol component is used in the form of an emulsion, in which case ionic and/or nonionic surfactants can be used as emulsifiers. The stability of the resulting emulsions is not described.

WO-96/12759 describes that in the production of PU foams the solubility of hydrocarbons as propellants in the polyols can be improved by adding castor oil. However, in Example 1, in the case of a polyetherpolyol-based mixture, however, it should also be noted that upon the addition of relatively high fractions of castor oil, the mixture separates again, and the homogeneity is accordingly lost again.

The emulsifiers listed in the prior art can only be prepared via complex multistage syntheses and, furthermore, the mixtures comprise components which cannot be used equally in all technical fields of application of the polyurethane foams, or are even incompatible.

It was an object of the present invention to overcome the disadvantages of the prior art and to provide compatibilizing agents for immiscible polyol compositions.

Surprisingly, it has been found that amphiphilic polymers with high molecular weight such as polyethers containing urethane or urea groups are able to achieve this object.

The invention therefore provides polyethers containing urethane or urea groups, their preparation and their use as compatibilizing agents for polyol compositions comprising at least two immiscible polyols, obtained by the reaction of
A. at least one di- and/or polyisocyanate with
B. (a) at least one hydrophilic polyether which randomly carries at least one OH and/or NH₂ and/or NH function and
   (b) at least one hydrophobic polyether which randomly comprises at least one OH and/or NH₂ and/or NH function and
   (c) optionally further compounds which carry at least one OH and/or NH₂ and/or NH function and/or other isocyanate-reactive groups such as carboxylic acid or epoxide functions,
      with the proviso that at least one isocyanate A is difunctional or multifunctional.

This invention further provides the advantageous use of polyols prepared from renewable raw materials in the polyol compositions.

During the preparation of the compounds listed above, the hydrophobic polyethers are thus joined to the hydrophilic polyethers.

During the reaction of isocyanates (A) with alcohols or amines, the corresponding urethane or urea derivatives are formed. During the reaction of the components listed above, compounds are formed in the form of mixtures, the distribution of which is determined by the reaction procedure but also by the laws of statistics.

Suitable di- or multifunctional isocyanates may either be aromatic or aliphatic. Examples are methylene diphenylisocyanate (MDI), toluene diisocyanate (TDI), 1,6-hexamethylene diisocyanate, 1-isocyanato-3,5,5-trimethyl-1,3-isocyanatomethylcyclohexane (IPDI) or polymethylene diphenylisocyanate (PMDI). Also of suitability are, furthermore, trifunctional and multifunctional isocyanates which are available, for example, under the trade names Desmodur® N 100, Desmodur N 3200, Desmodur N 3300 and Desmodur® N 3600 (Desmodur is a trade name of Bayer Material Science AG). In combination with multifunctional isocyanates, it is also possible to use monofunctional isocyanates in the reaction mixture especially for controlling the polarity and molecular weight distribution.

The term hydrophilic polyethers (component B (a)) is used here to refer to those polyethers in which more than 60 mol % of the alkoxy units are ethylene oxide units. The term hydrophobic polyethers (component B (b)) is used here to refer to those polyethers in which at most 45 mol % of the alkoxy units are ethylene oxide units.

Suitable polyethers can be obtained through reaction of a starter, which is preferably an alcohol, an amine or an alkanolamine, through addition reaction of monomers. Starting alcohols can be, for example, water, methanol, ethanol, 1-butanol, bisphenol-A, 2-aminoethanol, ethylene glycol, propylene glycol, glycerol, oligo- and polyglycerols, 1,3-dihydroxypropane, 1,4-dihydroxybutane, 1,6-dihydroxyhexane, 1,2,4-trihydroxybutane, 1,2,6-trihydroxyhexane, 1,1,1-trimethylolpropane, pentaerythritol, oligomers of pentaerythritols, polycaprolactone, xylitol, arabitol, sorbitol, mannitol, ethylenediamine, ammonia, 1,2,3,4-tetrahydroxybutane, castor oil or fructose.

The oligo- or polyglycerols are firstly linear compounds of the general formula

HO—CH₂—CH(OH)—CH₂—O—[CH₂—CH(OH)—CH₂—O]ₙ—H

in which
n is 1 to 9, preferably 1 to 6, in particular 1 to 3, specifically 1 and 2; which may be present as pure substances or else in a statistical mixture with one another and whose average value of the statistical distribution corresponds to the value “n”.

It therefore goes without saying that the index numbers given in the formulae listed here and the value ranges of the stated indices are the average values of the possible statistical distribution of the actual isolated structures and/or mixtures thereof. This also applies for structural formulae reproduced exactly as such per se.

Moreover, the polyglycerols used can also be branched and contain cyclic fractions. They comprise, for example, 0 to 5% by weight of glycerol, 15 to 40% by weight of diglycerol, 30 to 55% by weight of triglycerol, 10 to 25% by weight of tetraglycerol, 0 to 10% by weight of higher oligomers. The preferably used polyglycerols comprise 15 to 35% by weight of diglycerol, 38 to 52% by weight of triglycerol, 15 to 25% by weight of tetraglycerol, <10% by weight of higher oligomers and <2% by weight of cyclic compounds. Particular preference is given to using polyglycerols which comprise diglycerol in the statistical average.

Suitable monomers are, for example, ethylene oxide, propylene oxide, compounds from the group tetrahydrofuran, 1,2-epoxybutane (n-butylene oxide), 2,3-epoxybutane (isobutylene oxide), and also dodecyl oxide. In this connection, the distribution of the monomers can be chosen arbitrarily such that, for example, blocks may be present. Furthermore, it is also possible to use a mixture of the monomers, so that polyethers are obtained in which the units are present in statistical distribution or are gradually distributed. Such polyethers can be arranged randomly or have a block structure. The indices of structural formulae in this application are therefore to be understood as meaning positive real numerical values and not only as whole-numbered numerical values.

Suitable hydrophilic polyethers (component B(a)) which carry one or more active hydrogen atoms can be described by formula (I)

(R¹)ₒ[R²[(E)_{q}-(P)ᵣ≦R³]ₚ]ₛ (I)

where
R¹ when o=1, is the s-functional nonreactive fractions of an initiator,
R² independently of one another, are O, NR⁴, NH or N,
E is an ethoxy function, preferably the radical —(CH₂—CH₂—O),
P is identical or different alkoxy function(s) with at least three carbon atoms,
R³ is identical or different radicals from the group H, —CₜH₂ₜ—N(R⁴)H and/or —CₜH₂ₜ—NH₂,
R⁴ is identical or different alkyl or aryl functions having 1 to 20 carbon atoms, preferably methyl, ethyl or phenyl,
o is 0 or 1,
p is 1, 2 or 3,
q is 10 to 500, preferably 15 to 400, in particular 20 to 300,
r is 0 to 330, preferably 1 to 200, in particular 2 to 100,
s is 1 to 10, preferably 2 to 8, in particular 2 to 4,
t is 2 to 5,
with the proviso that
q is >0.6*(q+r), and
   which may be present as pure substances or in a statistical mixture with one another and whose average value of the statistical distribution corresponds to the value of the indices o to t.

Suitable hydrophobic polyethers (component B (b)) which carry one or more active hydrogen atoms can likewise be described with formula (I),

where
q is 0 to 400, preferably 1 to 300, in particular 2 to 200,
r is 10 to 500, preferably 15 to 400, in particular 20 to 300,
with the proviso that
q is <0.45*(q+r), and
   which may be present as pure substances or in a statistical mixture with one another and whose average value of the statistical distribution corresponds to the value of the indices o to t.

The polyethers described with the formula (I) can optionally be further modified by the process of graft polymerisation. For this, the polyethers are reacted with monomers carrying double bonds in the presence of free-radical activators. By adjusting the degree of grafting and the amount and type of monomers used or through the procedure for producing the copolymers, it is possible to change the properties of the polyethers in a targeted manner. Suitable monomers are, for example, methyl methacrylate, acrylic acid, styrene or maleic anhydride. One such process is described, for example, in the laid-open specification DE-1111 394(GB 969965). The polyethers described in this literature can also be used according to the invention if they statistically carry at least one OH and/or NH₂ and/or NH function. The content of the above-listed literature and patent literature relating to the chemical characterisation of the polyethers is therefore hereby incorporated by reference and forms part of the disclosure of the present application. Specific examples of suitable hydrophilic polyethers are:

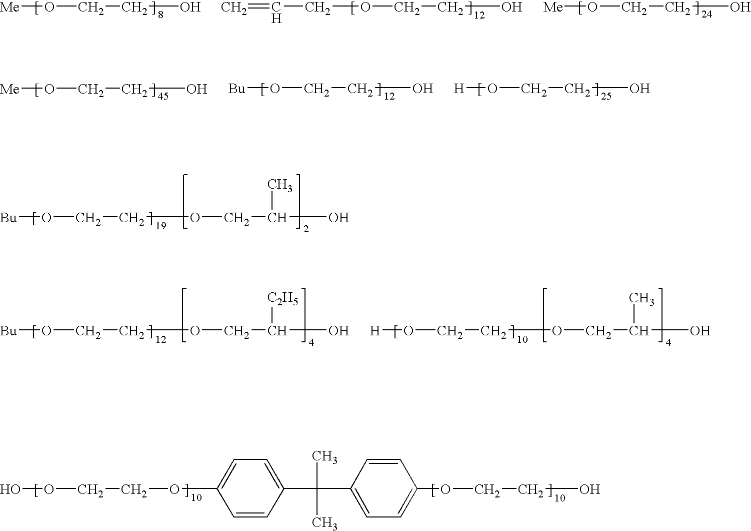

which may be present as pure substances or in a statistical mixture with one another and whose average value of the statistical distribution corresponds to the value of the indices.

Specific examples of suitable hydrophobic polyethers are:

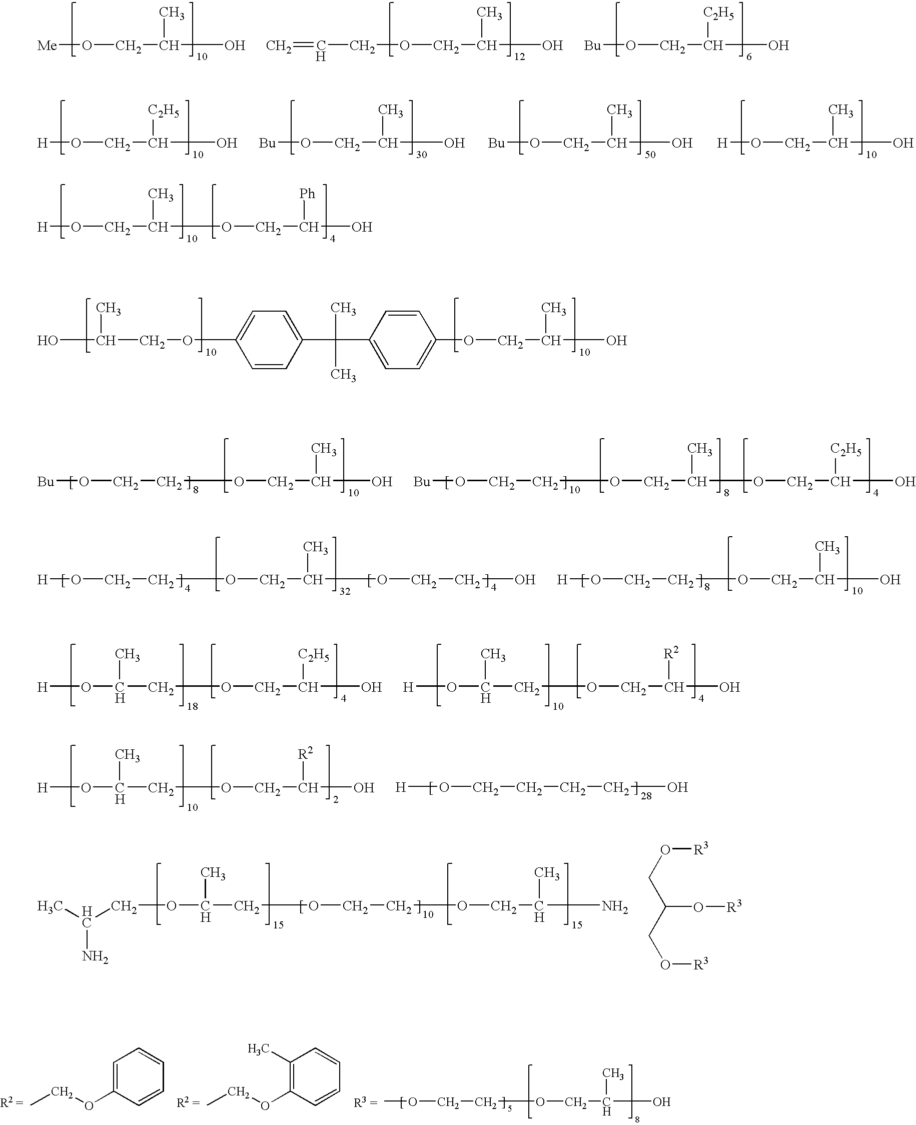

which may be present as pure substances or in a statistical mixture with one another and whose stated numerical value corresponds to the average value of the statistical distribution of the value of the indices.

Further compounds (c) which carry at least one OH and/or NH₂ and/or NH function and/or other isocyanate-reactive groups, such as carboxylic acid or epoxide functions, are, for example, polyethers which do not belong to the aforementioned hydrophilic or hydrophobic polyethers a) and b) used according to the invention, monohydric alcohols, such as methanol, ethanol, fatty alcohols, poly(ethylene-co-1,2-butylene)monool, fluorinated alcohols such as C₆F₁₃—CH₂CH₂OH, alkylphenols, or polyhydric alcohols, such as 1,2-propanediol, 1,6-hexanediol, poly(ethylene-co-1,2-butylene)diol, poly(hexamethylene carbonate)diol, glucose, fructose, polyglycerol, polyestermonools or polyesterdiols, such as poly(caprolactone)diol or poly(hexamethylene phthalate)diol or fluorinated polyethers.

Further suitable compounds (c) are, for example, fatty-acid-modified alcohols. These are di- or polyhydric alcohols in which the OH functions are partially esterified.

Further suitable compounds are primary and secondary amines with active hydrogen atoms, such as, for example, ethylamine, 1,6-hexamethylenediamine, diethylenetriamine, polyetheramines, polyethyleneimine or, for example, poly(acrylonitrile-co-butadiene) with amine end groups.

Further suitable compounds (c) are, for example, fatty-acid-modified amines. These are di- or polyfunctional amines in which the amine groups are partially amidated.

Moreover, alkanolamines, such as, for example, diethanolamine or ethanolamine, are suitable. Here too, the OH or the amine functions can be present in partially esterified or amidated form.

The reaction of various polyethers with multifunctional isocyanates permits the precise adjustment of the ratio of hydrophilic to hydrophobic structural elements through the selection of the amount and type of hydrophilic and hydrophobic polyethers. Furthermore, by incorporating further alcohols or amines, it is possible to incorporate, in a targeted manner, various other types of hydrophobic or hydrophilic structural elements. For example, when using 1,6-hexanediol, a hydrophobic alkylene block is formed, and by using dimethylolpropanoic acid, a structural element with a carboxylic acid functionality is formed.

In addition, by exploiting differences in reactivity between various isocyanate functions in a multifunctional isocyanate, it is possible to preferentially form certain structures. For example, through the formation of prepolymers for the formation of certain block or branched structures.

Exploiting the differences in reactivity of various OH, NH₂ or NH functions permits the same.

Predictions about effectiveness of a compatibilizing agent can only be made to a certain extent. The person skilled in the art is therefore required to try out the variation possibilities in a largely empirical way.

The invention further provides the use of urethane or urea derivatives as compatibilizing agents in which polyesterdiols are used as component (c).

The invention further provides homogeneous polyol mixtures comprising polyols based on renewable raw materials, in particular vegetable-based polyols, optionally a mixture with polyesterdiols or polyesterpolyols.

The invention further provides homogeneous polyol mixtures comprising these compatibilizing agents and optionally further auxiliaries and additives.

The invention further provides polyol mixtures consisting of polyesterpolyols and polyols based on renewable raw materials, in particular vegetable-based polyols, for producing PU foams (rigid foams), optionally comprising further auxiliaries and additives.

The invention further provides polyol mixtures comprising compatibilizing agent, consisting of at least two immiscible polyetherpolyols with differing content of polyethylene oxide units for use in the preparation of polyurethane and/or polyisocyanurate and/or polyurea foams, optionally comprising further auxiliaries and additives.

This invention further provides the advantageous use of polyols prepared from renewable raw materials in the polyol compositions.

Obtainable from the homogeneous mixtures using the compatibilizing agents are (homogeneous) reactive mixtures which consist of:
(I) the homogeneous polyol mixtures, comprising these compatibilizing agents and optionally further auxiliaries and additives, and
(II) one or more isocyanates.

Compatibilized polyol mixtures which, upon reaction with polyisocyanates, are suitable for the preparation of polyurethane and/or polyisocyanurate and/or polyurea foams.

The invention further provides polyurethane and/or polyisocyanurate and/or polyurea foams prepared using the compatibilized polyol mixtures.

The polyurethane foams prepared in this way can be used for producing moulding masses, paints, coatings, films, fibres and foams.

The invention also provides the polyethers containing urethane or urea groups themselves, obtained by the reaction of
A. at least one di- and/or polyisocyanate with
B. (a) at least one hydrophilic polyether which randomly carries at least one OH and/or NH₂ and/or NH function and
   (b) at least one hydrophobic polyether which randomly comprises at least one OH and/or NH₂ and/or NH function and
   (c) optionally further compounds which carry at least one OH and/or NH₂ and/or NH function and/or other isocyanate-reactive groups such as carboxylic acid or epoxide functions, and
      with the proviso that at least one isocyanate A is difunctional or multifunctional.

Number average molecular weight (Mn) for the products of the invention are between 4000-80000 g/mol, preferably 6000-60000 g/mol and most preferably 8000-30000 g/mol. Weight average molecular weight (Mw) for the products of the invention are between 10000-1000000 g/mol, preferably 20000-600000 g/mol and most preferably 25000-400000 g/mol.

The invention further provides the polyol mixtures prepared by adding the compatibilizing agents according to the invention and stabilised against phase separation which can optionally also comprise further auxiliaries and additives.

Auxiliaries and additives are understood here as meaning, inter alia, propellants, stabilisers, catalysts, flame retardants, pigments, dyes and further substances, such as, for example, but not mentioned exhaustively, also biocides, antistatic agents, etc., which are required for the preparation and use of the polyurethane foam.

The invention further provides polyurethane foams prepared using the homogeneous polyol mixtures according to the invention.

The compatibilizing agents according to the invention are particularly preferably used in polyol mixtures which comprise polyesterpolyols and natural-oil-based polyols (NOPs) since these two classes of polyols often have a tendency for phase separation upon mixing.

Mixtures of this type are often used in the preparation of polyurethane or polyisocyanurate rigid foams.

Furthermore, the use of the compatibilizing agents according to the invention in polyetherpolyol mixtures whose individual components have different polarities is preferred. This may be brought about, for example, by a different fraction of polyethylene glycol.

Mixtures with compatibilizing agents according to the invention can thus also advantageously be used in the preparation of flexible foam systems; these have particular mechanical properties such as, for example, viscoelasticity or high elasticity. Hitherto, such (inhomogeneous) mixtures could only be kept homogeneous through agitation.

Through the compatibilizing properties of the described structures, it is likewise possible to improve/change the solubility of propellants; such an effect is described for alcohol alkoxides in WO-2007/094780.

All suitable polyols can be used for the preparation of the foams. These may be polyether- or polyesterpolyols which typically carry 2 to 6 OH groups per molecule and, besides carbon, hydrogen and oxygen, can also contain heteroatoms such as nitrogen, phosphorus or halogens.

Corresponding to the required properties of the foams, special polyols are used, as described, for example, in: US-2007/0072951, WO-2007/111828, US-20070238800, U.S. Pat. No. 6,359,022 and WO-9612759(U.S. Pat. No. 5,451,615).

Vegetable-oil-based polyols are likewise described in various patent specifications, such as, for example, in WO-2006/094227(US2007037953 ), WO-2004/096882(US 2006293400), US-2002/0103091, WO-2006/116456(US 2006264524) and EP-1678232(US 2005070620).

Polyisocyanates which can be used for the preparation of the polyurethane foams are the compounds customary in this field for the particular foam types, as are given, for example, in EP-1712578(US2006235100), EP-1161474,WO-058383, US-2007/0072951, EP-1678232 (US2005070620) and WO-2005/085310 (US2007270518). Likewise of suitability are compounds carrying the multifunctional groups listed above (isocyanates and polyols), which are used for the preparation of the compatibilizing agents according to the invention.

To prepare a foam, a propellant is required. All known propellants can be used. This may be water as chemical propellant which releases carbon dioxide through reaction with the isocyanates. However, it is also possible to directly use carbon dioxide, or other propellants which are evaporated as a result of a suitable boiling point during the exothermic reaction, as physical propellant.

Examples thereof are halogenated hydrocarbons or hydrocarbons such as, for example, pentane isomers. Combinations of the two methods are also possible.

The urethane foam reaction is usually triggered and/or controlled by suitable catalysts. For example, tertiary amines or metal-containing catalysts (comprising tin, potassium, zinc compounds) are used here.

Stabilisers which can be used are the substances known according to the prior art. In most cases, these are organically modified siloxanes as are described, for example, in EP-0839852(U.S. Pat. No. 6,071,977), WO-2005/118668, US-20070072951, DE-2533074(US4,042,540), EP-1537159(US2006167125), EP-1712576(US2006229375), EP-1544235(U.S. Pat. No. 7,183,330), EP-0533202, U.S. Pat. No. 3,933,695, EP-0780414(U.S. Pat. No. 5,807,903), DE-4239054(U.S. Pat. No. 5,321,051), DE-4229402(U.S. Pat. No. 5,306,737), DE-102004001408, EP-0867465(U.S. Pat. No. 5,844,010) and the documents cited therein.

The auxiliaries and additives which can be used for the preparation of the polyurethane foams, such as, for example, catalysts, stabilisers, flame retardants, propellants, are likewise the components known from the prior art. A comprehensive depiction of the prior art, of the raw materials used and methods which can be used is given in G. Oertel (ed.): “Kunststoffhandbuch [Polymer Handbook]”, volume VII, C. Hanser Verlag, Munich, 1983, in Houben-Weyl: “Methoden der organischen Chemie [Methods of organic chemistry]”, volume E20, Thieme Verlag, Stuttgart 1987, (3), pages 1561 to 1757, and in “Ullmann's Encyclopedia of Industrial Chemistry” Vol. A21, VCH, Weinheim, 4th edition 1992, pages 665 to 715.

The compatibilizing agents according to the invention and their use are described below by way of example without any intention to limit the invention to these exemplary embodiments. Where ranges, general formulae or compound classes are given below, these are intended to not only include the corresponding ranges or groups of compounds which are explicitly mentioned, but also part ranges and subgroups of compounds which can be obtained by removing individual values (ranges) or compounds. If documents are cited in the course of the present description, then their content should belong in its entirety to the disclosure of the present invention.

### WORKING EXAMPLES

The examples below should serve to illustrate the invention, but not represent any kind of limitation.

The invention is further described by the following non-limiting examples which further illustrate the invention, and are not intended, nor should they be interpreted to, limit the scope of the invention.

One indicator of storage stability is homogeneity. Within the context of this application, homogeneous compositions are to be regarded as those which, for example upon standing in a 100 ml glass cylinder over a given period (in hours) at the stated room temperature, reveal no phase separation of more than 3 ml. Such a result is referred to as “good”. If the homogeneity is present even over a longer period or else if the phase formation is significantly less than 50% of the pregiven value, then the result is to be referred to as “very good”. If, on the other hand, phase formation is more marked and greater than 150% of the pregiven value, then the result is to be referred to as “adequate”, in the case of more than 200% as “unsatisfactory”.

In general, it was found that the storage stability is poorer at higher temperature. However, in practice during transportation or storage of a polyol mixture, said mixture is often not processed at room temperature but heated to 30-40° C. For this reason, the experiments were carried out at temperatures of 20 and 40° C.

Method for determining the molecular masses and average mass distribution: gel permiation chromatography using an Instrument: HP1100 equipped with a combination of GPC columns SDV 1000/10000A having a length of 65 cm at a temperature of 30° C. Solvent used is THF, calibration against polystyrene. Mn found for the products: 8000-15000 g/mol Mw found for the products: 30000-250000 g/mol.

Preparation of the compatibilizing agent:

### Example 1

28 g of a hydrophobic polyethermonool (butanol-started, M=ca. 1800 g/mol, w(EO)=0%) were mixed with 36 g of a hydrophobic polyetherdiol (M=ca. 2200 g/mol, w(EO)=10%) and 24 g of a hydrophilic polyethermonool (methanol-started, M=1100 g/mol, w(EO)=100%), and 13 g of Desmodur N 3200 (technical-grade trifunctional isocyanate from Bayer AG) was added. 100 g of propylene carbonate were then also added. This mixture was heated to 100° C. and then admixed with 0.1 g of Tegokat 722 (bi-octoate) (obtainable from TIB Mannheim). The mixture was then stirred for a further 4 hours at this temperature.

### Example 2

26 g of a hydrophobic polyethermonool (butanol-started, M=ca. 1800 g/mol, w(EO)=0%) were mixed with 34 g of a hydrophobic polyetherdiol (M=ca. 2200 g/mol, w(EO)=10%), 15 g of a hydrophilic polyethermonool (methanol-started, M=1100 g/mol, w(EO)=100%) and 14 g of a hydrophilic polyethermonool (M=2000 g/mol, w(EO)=100%), and 12 g of Desmodur N 3200 (technical-grade trifunctional isocyanate from Bayer AG) were added. 100 g of propylene carbonate were then also added. This mixture was heated to 100° C. and then admixed with 0.1 g of Tegokat 722 (bi-octoate) (obtainable from TIB Mannheim). The mixture was then stirred for a further 4 hours at this temperature.

### Example 3

34 g of a hydrophobic polyethermonool (butanol-started, M=ca. 1800 g/mol, w(EO)=0%) were mixed with 30 g of a hydrophobic polyetherdiol (M=ca. 2200 g/mol, w(EO)=10%) and 25 g of a hydrophilic polyethermonool (methanol-started, M=2000 g/mol, w(EO)=100%), and 11 g of Desmodur N 3200 (technical-grade trifunctional isocyanate from Bayer AG) were added. 100 g of propylene carbonate were then also added. This mixture was heated to 100° C. and finally admixed with 0.1 g of Tegokat 722 (bi-octoate)(available from TIB Mannheim). The mixture was then stirred for a further 4 hours at this temperature.

### Example 4

23 g of a hydrophobic polyethermonool (butanol-started, M=ca. 1800 g/mol, w(EO)=0%) were mixed with 30 g of a hydrophobic polyetherdiol (M=ca. 2200 g/mol, w(EO)=10%) and 37 g of a hydrophilic polyethermonool (methanol-started, M=2000 g/mol, w(EO)=100%), and 10 g of Desmodur N 3200 (technical-grade trifunctional isocyanate from Bayer AG) were added. 100 g of propylene carbonate were then also added. This mixture was heated to 100° C. and finally treated with 0.1 g of Tegokat 722 (bi-octoate) (obtainable from TIB Mannheim). The mixture was then stirred for a further 4 hours at this temperature.

### Comparative Example 1

Pluronic 10500 (A-B-A block polyether from BASF AG) was used as comparative example. The mass fraction of ethylene oxide units is 50%.

### Comparative Example 2

Vorasurf 504

Vorasurf 504 (A-B-A block polyether of butylene oxide and ethylene oxide from DOW) was used as a further comparative example.

### Comparative Example 3

A nonylphenol ethoxylate with 40 EO, as is used in US 2007 0238800 was used as a further comparative example.

Use of the compatibilizing agents in polyol mixtures:

Storage experiments with various polyol mixtures were carried out.

Raw materials used:
Polyol A: Stepanpol PS 2352 (from Stepan)
Polyol B: Stepanpol PS 1922 (from Stepan)
Polyol C: Terol 563 (from Oxid)
Polyol D: Terate 7540 (from Invista)
Polyol E: Terate 2541 (from Invista)
Polyol F: Caster oil (Alberding+Boley, Krefeld)
Polyol G: Voranol 3322 (from Dow)
Polyol H: EO-rich polyol, Voranol CP 1421 (from Dow)
Polyol I: Vegetable-oil-based polyol BiOH™ 5000 from Cargill
Polyol K: Hyperlite® Polyol 1629 (from Bayer)
Polyol L: Trimethylolpropane-started polyglycol, ethylene oxide based with molar mass 1200 g/mol.

Table 1 sunmarises the polyol components used and their fractions, the respective compatibilizing agents and their fractions, the storage temperature and the stability of the mixtures. The stability was assessed visually at the following intervals: 2 h, 4 h, 8 h, 16 h, 24 h, 36 h, 48 h and then at intervals of 24 h and a qualitative assessment was made.

| | Polyol, | Polyol, | Compat., | | |
|---|---|---|---|---|---|
| Ex. | parts | parts | parts | Temp. | Stability |
| 5 | A, 46 | F, 50 | Ex. 1, 4 | 40° C. | 48 h, good |
| 6 | A, 46 | F, 50 | Ex. 2, 4 | 40° C. | 48 h, good |
| 7 | A, 46 | F, 50 | Ex. 3, 4 | 40° C. | 40 h, good |
| 8 | A, 46 | F, 50 | Ex. 4, 4 | 40° C. | 48 h, very good |
| 9 | C, 46 | F, 50 | Ex. 1, 4 | 40° C. | 264 h, very good |
| 10 | D, 46 | F, 50 | Ex. 1, 4 | 40° C. | 264 h, very good |
| 11 | E, 46 | F, 50 | Ex. 1, 4 | 40° C. | 264 h, very good |
| 12 | A, 46 | F, 50 | Ex. 1, 5 | 40° C. | 240 h, very good |
| 13 | B, 46 | F, 50 | Ex. 1, 4 | 40° C. | 288 h, very good |
| 14 | A, 76 | F, 20 | Ex. 1, 4 | 40° C. | 72 h, good |
| 15 | B, 76 | F, 20 | Ex. 1, 4 | 40° C. | 48 h, good |
| 16 | A, 76 | F, 20 | Ex. 4, 4 | 40° C. | 48 h, good |
| 17 | B, 76 | F, 20 | Ex. 4, 4 | 40° C. | 48 h, good |
| 18 | A, 76 | F, 20 | Ex. 4, 4 | 20° C. | 480 h, good |
| 19 | A, 77 | F, 20 | Ex. 4, 3 | 20° C. | 480 h, good |
| 20 | A, 78 | F, 20 | Ex. 4, 2 | 20° C. | 480 h, very good |
| 21 | G, 66 | H, 30 | Ex. 1, 4 | 20° C. | 48 h, good |
| 22 | G, 30 | H, 66 | Ex. 1, 4 | 20° C. | 120 h, good |
| 23 | G, 66 | I, 30 | Ex. 1, 4 | 40° C. | 120 h, good |
| 24*⁾ | G, 66 | I, 30 | Ex. 1, 4 | 40° C. | 120 h, good |
| 25*⁾ | G, 30 | I, 66 | Ex. 1, 4 | 40° C. | 120 h, good |
| 26*⁾ | G, 66 | I, 30 | Ex. 1, 4 | 20° C. | 240 h, good |
| 27 | K, 88 | H, 10 | Ex. 1, 2 | 20° C. | 120 h, good |
| 28 | G, 66 | L, 30 | Ex. 1, 4 | 20° C. | 120 h, good |
| Comp. 4 | A, 50 | F, 50 | | 40° C. | <16 h, |
| | | | | | unsatisfactory |
| Comp. 5 | C, 50 | F, 50 | | 40° C. | <16 h, |
| | | | | | unsatisfactory |
| Comp. 6 | D, 50 | F, 50 | | 40° C. | <16 h, |
| | | | | | unsatisfactory |
| Comp. 7 | E, 50 | F, 50 | | 40° C. | <16 h, |
| | | | | | unsatisfactory |
| Comp. 8 | B, 50 | F, 50 | | 40° C. | <16 h, |
| | | | | | unsatisfactory |
| Comp. 9 | A, 76 | F, 20 | Comp. 2, | 40° C. | <4 h, |
| | | | 4 | | unsatisfactory |
| Comp. 10 | A, 76 | F, 20 | Comp. 1, | 40° C. | <2 h, |
| | | | 4 | | unsatisfactory |
| Comp. 11 | B, 76 | F, 20 | Comp. 2, | 40° C. | <4 h, |
| | | | 4 | | unsatisfactory |
| Comp. 12 | B, 76 | F, 20 | Comp. 1, | 40° C. | <2 h, |
| | | | 4 | | unsatisfactory |
| Comp. 13 | A, 76 | F, 20 | Comp. 3, | 40° C. | <4 h, |
| | | | 4 | | unsatisfactory |
| Comp. 14 | G, 70 | H, 30 | | 20° C. | <8 h, |
| | | | | | unsatisfactory |
| Comp. 15 | G, 30 | H, 70 | | 20° C. | <4 h, |
| | | | | | unsatisfactory |
| Comp. 16*⁾ | G, 70 | I, 30 | | 40° C. | 24 h, |
| | | | | | unsatisfactory |
| Comp. 17*⁾ | G, 30 | I, 70 | | 40° C. | 24 h, |
| | | | | | unsatisfactory |
| Comp. 18 | 70 | L, 30 | | 20° C. | 4 h, |
| | | | | | unsatisfactory |

*⁾The mixture was additionally admixed with 2 parts of water.

The examples show that the storage stability of the polyol mixtures can be improved considerably through the use of the compatibilizing agents according to the invention. The comparative examples in which no or noninventive compatibilizing agents were used exhibit a significantly lower storage stability.

For example, in Comp. 9 and Comp. 10, even after 4 and 2 hours, respectively, an unsatisfactory stability is observed, whereas in Example 16 the polyol mixture still has good stability after 48 hours.

Preparation of PU foams:

Testing in the rigid foam:

### Example 29

For the applications-related testing of the formulations according to the invention, the following foam formulation was used:

| Component | Use amount | |
|---|---|---|
| Polyol* | 100 | parts |
| DMCHA | 1.5 | parts |
| Water | 2 | parts |
| TCPP | 15 | parts |
| Kosmos 75 MEG | 3.5 | parts |
| n-Pentane | 12 | parts |
| TEGOSTAB B 8469 | 2 | parts |
| MDI** | 205.7 | parts |

*Mixture from Example 16 after storage for 12 h
**Polymeric MDI, 200 mPa*s, 31.5% NCO, functionality 2.7
DMCHA: Dimethylcyclohexylamine serves as aminic catalyst, TCPP: trischloropropyl phosphate is a flame retardant, Kosmos 75 MEG is a metal-based catalyst from Goldschmidt, TEGOSTAB B 8469 is a foam stabiliser from Goldschmidt.

The foamings were carried out in the hand-mixing method. For this polyol, catalysts, water, flame retardants and propellants were weighed into a beaker and mixed using a disc stirrer (6 cm in diameter) for 30 s at 1000 rpm. By reweighing, the amount of propellant evaporated during the mixing operation was determined and replaced. The MDI was then added, the reaction mixture was stirred using the described stirrer for 5 s at 3000 rpm and immediately transferred to a box mould lined with paper measuring 27 cm×14 cm×14 cm. After curing, various samples were cut out of the foam and the following assessments and measurements were carried out:

The foam had a very fine cell structure. Bottom zone defects were not present.
Weight per unit volume: 23.5 kg/m³
Lambda value (parallel to the rise direction): 25.3 mW/m*K
Lambda value (perpendicular to the rise direction): 22.7 mW/m*K
10% compressive strength (parallel to the rise direction):
194 kPa
10% compressive strength (perpendicular to the rise direction):
52 kPa
Closed-cell fraction: 85.6%

### Comparative Example 19

Using the foam formulation described in Example 29, the polyol mixture from Comparative Example 10 following storage for 12 h was used as polyol component. Foaming resulted in collapse phenomena. A foam body of very low-grade quality was obtained.

Testing in the flexible foam:

### Example 30

The polyol mixtures according to the invention were investigated in a typical polyurethane hot flexible foam formulation:

Formulation for the preparation of the polyurethane hot flexible foams:

100 parts by weight of the polyol mixture from Example 23, 5.0 parts by weight of water (chemical propellant), 1.0 parts by weight of TEGOSTAB B 2370, 0.15 parts by weight of amine catalyst (triethylenediamine) 0.23 parts by weight of tin catalyst (tin 2-ethylhexanoate), 5.0 parts by weight of methylene chloride (additional physical propellant), 63.04 parts by weight of isocyanate (tolylene diisocyanate, TDI-80)(ratio of isocyanate groups to isocyanate-consuming reactive groups=1.15).

Procedure:

Polyol mixture, water, catalysts and stabiliser were initially introduced into a cardboard beaker and thoroughly mixed using a stirrer disc (45 s at 1000 rpm). The methylene chloride was then added and the mixture was mixed again for 10 s at 1000 rpm. The isocyanate (TDI-80) was then added and the mixture was stirred again at 2500 rpm for 7 s. The mixture was then poured into a box measuring 30 cm×30 cm×30 cm. During foaming, the rise height was measured using an ultrasound height measurement. The rise time refers to the time which elapses until the foam has reached its maximum rise height. The fall-back refers to the sinking down of the foam surface after the polyurethane hot flexible foam has been discharged. In this connection, the fall-back is measured 3 min after discharge. The weight per unit volume was measured in accordance with DIN EN ISO 845 and DIN EN ISO 823. The number of cells was counted using a magnifying glass with scaling to three positions and the values were averaged.

The following results were obtained:
Rise time: 89 s
Rise height: 34 cm
Fall-back: 0.4 cm
Weight per unit volume: 18.4 kg/m³
Number of cells: 7 cells/cm

Testing in the moulded foam:

### Example 31

The following formulation was used:

100 parts of polyol mixture as described in Example 27, 0.5 parts of TEGOSTAB® B 4113, 3 parts of water, 2 parts of triethanolamine, 0.6 parts of TEGOAMIN® 33 and 0.2 parts of diethanolamine and a mixture of 18.5 parts of polymeric MDI (44V20 from Bayer) and 27.7 parts of TDI (tolylene diisocyanate, T80).

The foams were prepared in the known way by mixing all of the components apart from the isocyanate in a beaker, then adding the isocyanate and stirring it in rapidly at a high stirrer speed. The reaction mixture is then introduced into a cuboid mould measuring 40×40×10 cm, which was heated to a temperature of 40° C. and the mass was left for 10 minutes to cure. The compressive forces were then measured. For this, the foam was compressed 10 times to 50% of its height. Here, the first measurement value (AD 1 in Newtons) is a measure of the open-cell fraction of the foam. Then, it was (manually) pressed down completely in order in the 11th measurement value (AD 11 in Newtons) to be able to determine the hardness of the compressed foam. The foam was then cut in order to assess skin and edge zone and to determine the number of cells (ZZ).

The following results were obtained:
AD 1: 1180 N
AD 11: 132 N
ZZ: 10 cells per cm

Skin and edge zone were assessed as “good”. This corresponds to a foam quality which corresponds to industrial requirements.

The foaming results show that using the mixtures according to the invention it is possible to prepare PU foams of good quality which do not have any of the disadvantages on account of mixing problems of the polyols. The compatibilizing agents according to the invention do not have an adverse effect on the foaming.

Having thus described in detail various embodiments of the present invention, it is to be understood that the invention defined by the above paragraphs is not to be limited to particular details set forth in the above description as many apparent variations thereof are possible without departing from the spirit or scope of the present invention.

1. A method of enhancing the storage stability of a polyol composition comprising adding a polyether containing urethane or urea groups as compatibilizing agent to a polyol composition comprising at least two immiscible polyols, obtained by the reaction of
A. at least one di- and/or polyisocyanate with
B. (a) at least one hydrophilic polyether which randomly carries at least one OH and/or NH₂ and/or NH function and
(b) at least one hydrophobic polyether which randomly comprises at least one OH and/or NH₂ and/or NH function and
(c) optionally further compounds which carry at least one OH and/or NH₂ and/or NH function and/or other isocyanate-reactive groups such as carboxylic acid or epoxide functions, and
with the proviso that at least one isocyanate A is difunctional or multifunctional.

2. The method of claim 1, characterized in that at least one polyether of the general formula (I)
(R¹)ₒ[R²[(E)_{q}-(P)ᵣR³]p]ₛ (I)
where
R¹ when o=1, is the s-functional nonreactive fractions of an initiator,
R² independently of one another, are O, NR⁴, NH or N,
E is an ethoxy function, preferably the radical —(CH₂—CH₂—O)—,
P is identical or different alkoxy function(s) with at least three carbon atoms,
R³ is identical or different radicals from the group H, —CₜH₂ₜ—N(R⁴)H and/or —CₜH₂ₜ—NH₂,
R⁴ is identical or different alkyl or aryl functions having 1 to 20 carbon atoms, preferably methyl, ethyl or phenyl,
o is 0 or 1,
p is 1, 2 or 3,
q is 10 to 500,
r is 0 to 330,
s is 1 to 10,
t is 2 to 5,
with the proviso that
q is >0.6*(q+r),
is used as component (a).

3. The method of claim 1, characterized in that at least one polyether of the general formula (I), where
q is 0 to 400,
r is 10 to 500,
with the proviso that
q is <0.45(q+r),
is used as component (b).

4. The method of claim 1, characterized in that at least one polyether of the general formula (I), where
q is 15 to 400,
r is 1 to 200,
s is 2 to 8,
is used as component (a).

5. The method of claim 1, characterized in that at least one polyether of the formulae 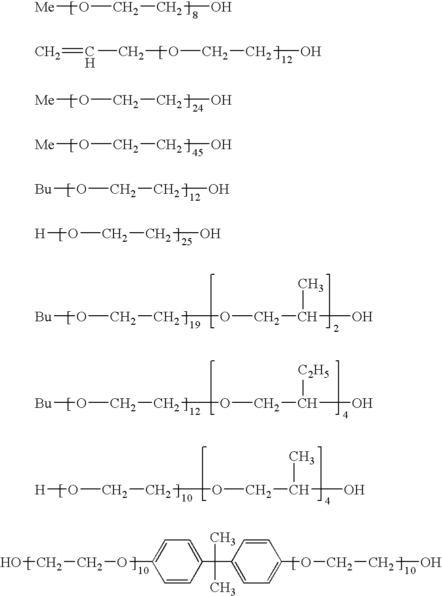
is used as component (a).

6. The method of claim 1, characterized in that at least one polyether of the formulae 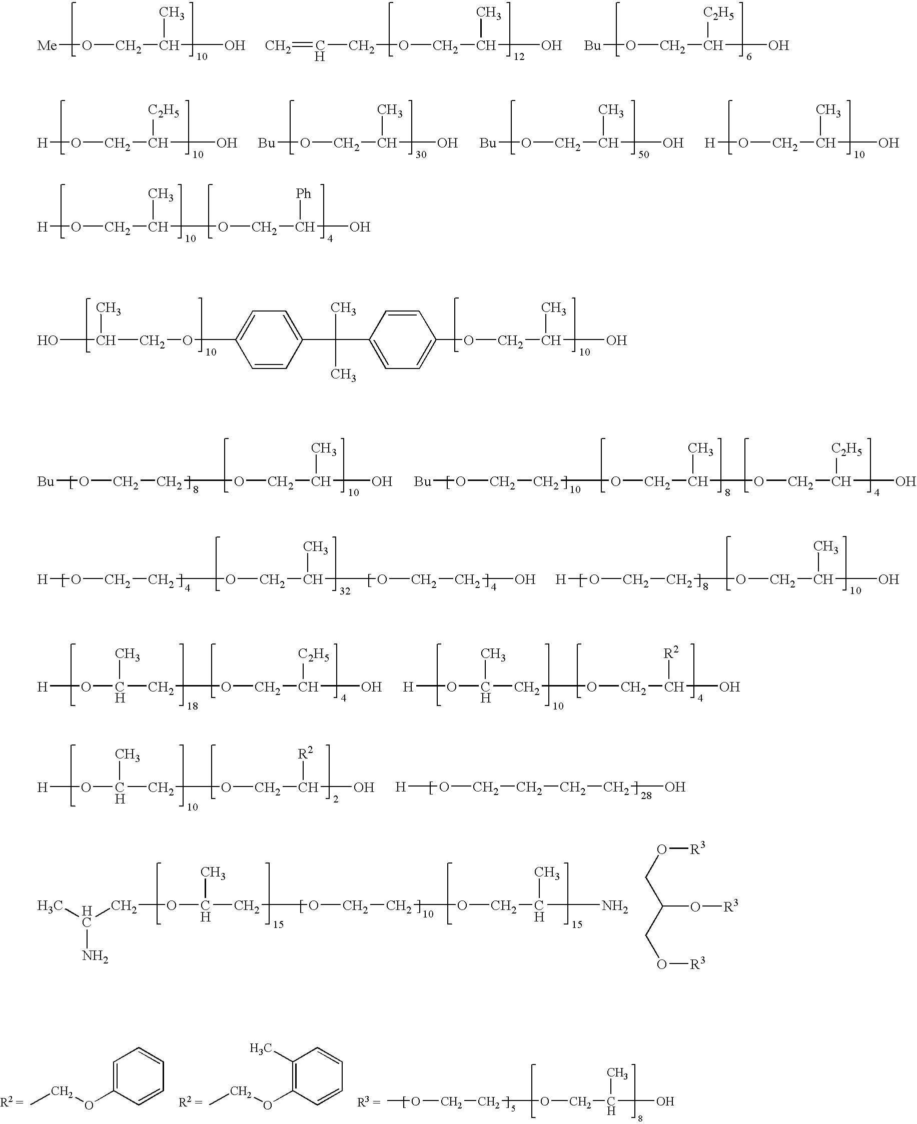
is used as component (b).

7. The method of claim 1, characterized in that polyesterdiols are used as component (c).

8. A polyol mixture comprising compatibilizing agents according to claim 1 furthermore comprising further auxiliaries and additives.

9. A polyol mixtures comprising compatibilizing agents according to claim 1, consisting of polyester polyols and vegetable-based polyols for the preparation of polyurethane and/or polyisocyanurate and/or polyurea foams, optionally comprising further auxiliaries and additives.

10. A polyol mixtures comprising compatibilizing agents according to claim 1, consisting of at least two immiscible polyetherpolyols with differing content of polyethylene oxide units for use in the preparation of polyurethane and/or polyisocyanurate and/or polyurea foams, optionally comprising further auxiliaries and additives.

11. A reactive mixture comprising
(I) homogeneous polyol mixtures comprising compatibilizing agents according to claim 1 and optionally further auxiliaries and additives and
(II) one or more isocyanates.

12. Polyurethane and/or polyisocyanurate and/or polyurea foams prepared using the polyol mixtures according to claim 8.

13. Polyethers containing urethane or urea groups obtained by the reaction of
A. at least one di- and/or polyisocyanate with
B. (a) at least one hydrophilic polyether which randomly carries at least one OH and/or NH₂ and/or NH function and
(b) at least one hydrophobic polyether which randomly comprises at least one OH and/or NH₂ and/or NH function and
(c) optionally further compounds which carry at least one OH and/or NH₂ and/or NH function and/or other isocyanate-reactive groups such as carboxylic acid or epoxide functions, and
with the proviso that at least one isocyanate A is difunctional or multifunctional.
